(19) United States
(12) Patent Application Publication
(10) Pub. No.: US 2018/0128642 A1
(43) Pub. Date: May 10, 2018

(54) METHOD FOR MANAGING AND DISPLAYING GEOREFERENCED GRAPHIC SYMBOLS AND ASSOCIATED DISPLAY DEVICE

(71) Applicant: THALES, COURBEVOIE (FR)

(72) Inventors: Thierry GANILLE, MERIGNAC (FR); Johanna LUX, LE HAILLAN (FR); Emmanuel MONVOISIN, BORDEAUX (FR)

(21) Appl. No.: 15/563,927

(22) PCT Filed: Apr. 13, 2016
(86) PCT No.: PCT/EP2016/058081

§ 371 Date: Oct. 2, 2017

(30) Foreign Application Priority Data
Apr. 17, 2015 (FR) 15/00804

(51) Int. Cl. G01C 23/00; G01C 21/20; G08G 5/00; G02B 27/01

(52) U.S. Cl. CPC G01C 23/005; G01C 21/20; G02B 2027/0183; G02B 27/0179; G02B 27/0172; G08G 5/0052

(57) ABSTRACT

A method is provided for managing and displaying symbols that are geo-referenced in a viewing device. The method is implemented in a synthetic viewing system comprising a navigation system, a cartographic database comprising a geo-referenced object, electronic calculation means to calculate the symbol which is itself geo-referenced representative of the geo-referenced object and a viewing device. The electronic calculation means are arranged so as to calculate the total surface area of the geo-referenced symbol to be displayed on the viewing device and a photometric and/or colorimetric coefficient representative of the conformal symbol, the photometric and/or colorimetric coefficient being a decreasing function of the total surface area. The photometric and/or colorimetric coefficient is a coefficient of opacity or of luminance or of hue or of saturation.

The general field of the invention is that of Man-System interfaces dedicated to the piloting or navigation of vehicles and in particular of aircraft. The more specific field of the invention is that of viewing systems presenting a three-dimensional synthetic view of the outside landscape comprising information in the form of a displayed symbology. These systems are known by the general acronym “SVS”, standing for “Synthetic Vision System”.

Generally, the symbology displayed comprises geo-referenced symbols representative of points of interest such as, for example, airports, radio navigation beacons or else waypoints of a flight plan. These symbols are displayed in the form of cones or other simple geometric shapes. They are disposed at the exact geographical coordinate that the point of interest occupies on the terrain.

These symbols are generally represented with dimensions corresponding to real objects. Consequently, according to the laws of perspective, the closer the symbol is to the craft, the more its appearance occupies space on the screen of the viewing device on which it is displayed.

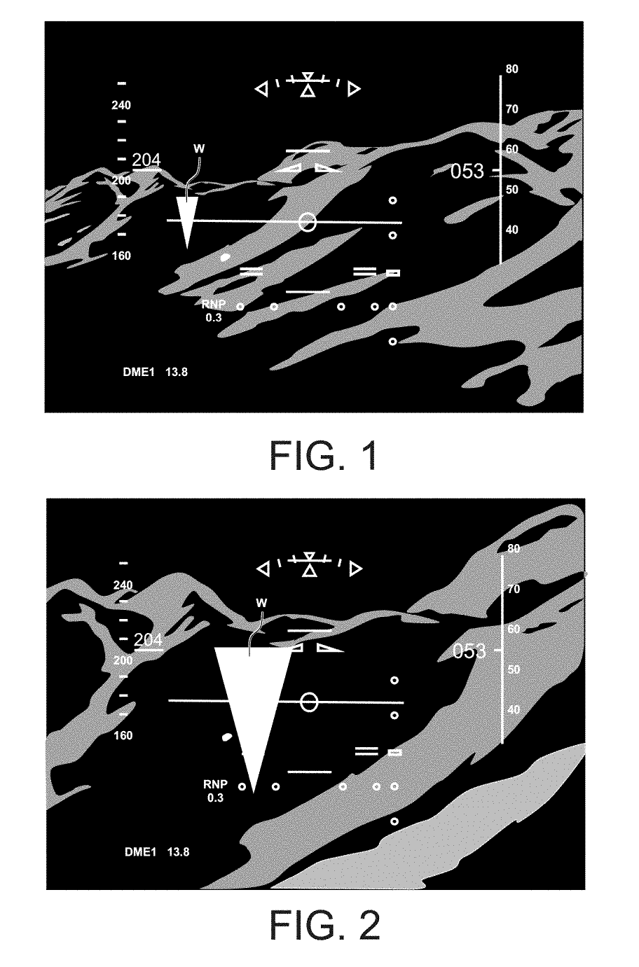

Thus, FIG. 1 represents an exemplary display on a “Head-Up” display or “HUD” of a synthetic representation of a terrain comprising a navigation symbology and a waypoint of the flight plan of the aircraft. This waypoint W is delineated by a cone geo-referenced in the synthetic landscape and its height indicates the altitude at which the aircraft must pass as it transits this point. In this FIG. 1, the landscape is represented in three-dimensional form in gray and black, the navigation symbology in white and the cone also in white. On an HUD, this representation conforms to the outside landscape, that is to say it is superimposed perfectly from the viewpoint of the pilot with reality.

As seen in this FIG. 1, if the waypoint is far away, the cone has a low footprint on the viewing screen. Conversely, as seen in FIG. 2, as the aircraft approaches the waypoint, the cone representing it enlarges and increases its screen footprint until it potentially occupies a very large part of the screen at the moment of its transit, hindering the readability of the other information displayed in the HUD as well as the pilot's outward vision in the case of a head-up display.

To solve this problem, patent U.S. Pat. No. 8,094,188 entitled “System, apparatus, and method for enhancing the image presented on an aircraft display unit through location highlighters” proposes to change the luminance of an object displayed as a function of its distance from the craft. The closer the virtual object, the lower its luminance.

A drawback of this technical solution is that the change of luminance is the same for all the objects whatever their size unless specific distances of change are defined for each type of object. Moreover, this technique does not apply to an areal object present in a two-dimensional representation of the environment of the aircraft such as, for example, an aeronautical zone on a cartographic background, which becomes more transparent or less transparent as a function of the zoom level.

The system according to the invention does not exhibit these drawbacks. Indeed, the graphical representation of a conformal object is not calculated as a function of its distance from the carrier but as a function of its footprint on the viewing screen. The main advantages of this solution are:
Independence with respect to the size, the shape or the orientation of the object in a three-dimensional representation;
Possible application to two-dimensional displays or the size of objects on the screen does not vary as a function of the distance but of the zoom applied to the representation;

Immediate adaptability to each type of screen since the appearance of an object depends directly on the resolution of the screen.

More precisely, a first subject of the invention is a method for managing and displaying a geo-referenced symbol, said method being implemented in a synthetic viewing system of an aircraft, said viewing system comprising at least one navigation system, a cartographic database, electronic calculation means and a viewing device displaying on a viewing screen a cartographic representation of the terrain overflown, said symbol representing a geo-referenced object, characterized in that said method comprises the following steps:
Step 1: Calculation of the total surface area of the geo-referenced symbol to be displayed on the viewing device;
Step 2: Calculation of a photometric and/or colorimetric coefficient representative of the geo-referenced symbol, said photometric and/or colorimetric coefficient being a decreasing function of the ratio of said total surface area to the surface area of the screen;
Step 3: Display of said symbol by the viewing system on the screen of the viewing device.

A second subject of the invention is a synthetic viewing system implementing this method. This viewing system comprises at least one navigation system, a cartographic database comprising at least one geo-referenced object, electronic calculation means making it possible to calculate a symbol representative of said geo-referenced object and a viewing device comprising a viewing screen displaying a cartographic representation of the terrain overflown, characterized in that said electronic calculation means are arranged so as to calculate the total surface area of the geo-referenced symbol to be displayed on the viewing device and a photometric and/or colorimetric coefficient representative of said geo-referenced symbol, said photometric and/or colorimetric coefficient being a decreasing function of the ratio of said total surface area to the surface area of the screen.

Advantageously, the viewing device is:

either a so-called “Head-Up” viewing device comprising an optical mixer making it possible to display the geo-referenced symbol on an outside landscape;

or a head-mounted viewing device comprising an optical mixer making it possible to display the geo-referenced symbol on an outside landscape;

or an instrument panel viewing device comprising a color viewing screen.

Advantageously, the graphical representation of the symbol is a three-dimensional perspective view or a two-dimensional view from above.

Advantageously the graphical representation of the symbol is represented on a synthetic cartographic background.

Advantageously, when the ratio of the total surface area to the surface area of the screen is less than a first determined threshold, said photometric and/or colorimetric coefficient is constant and equal to a maximum value—when the ratio of the total surface area to the surface area of the screen is greater than a second threshold, said photometric and/or colorimetric coefficient is constant and equal to a minimum value—when the ratio of the total surface area to the surface area of the screen lies between the first threshold and the second threshold, said photometric and/or colorimetric coefficient is inversely proportional to the ratio of the total surface area of the symbol to the surface area of the screen.

Advantageously, the first threshold and the second threshold are dependent on the size of the screen of the viewing device.

Advantageously, said photometric and/or colorimetric coefficient is a coefficient of opacity or of luminance or of hue or of saturation.

Advantageously, the outline of the symbol is blurred, the thickness of blur being an increasing function of the total surface area of said conformal symbol.

The invention will be better understood and other advantages will become apparent on reading the nonlimiting description which follows and by virtue of the appended figures among which:

FIGS. 1 and 2 already commented on represent a synthetic representation according to the prior art of a terrain comprising a navigation symbology and a waypoint of the flight plan of the aircraft according to two different viewpoints;

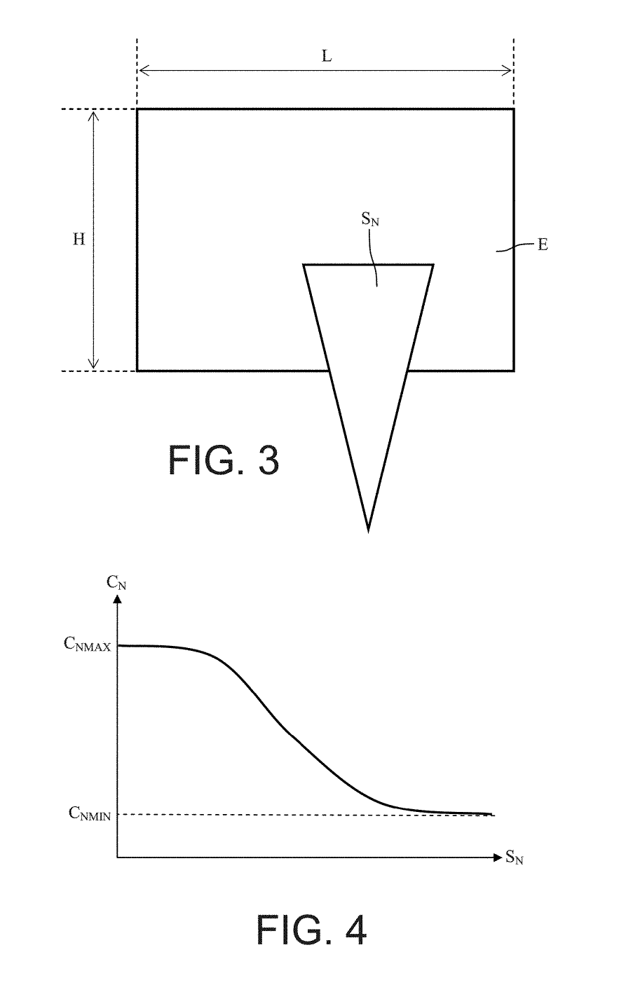

FIG. 3 represents the first step of calculation of the method for managing and displaying a conformal symbol according to the invention;

FIG. 4 represents the second step of calculation of the method for managing and displaying a geo-referenced symbol according to the invention;

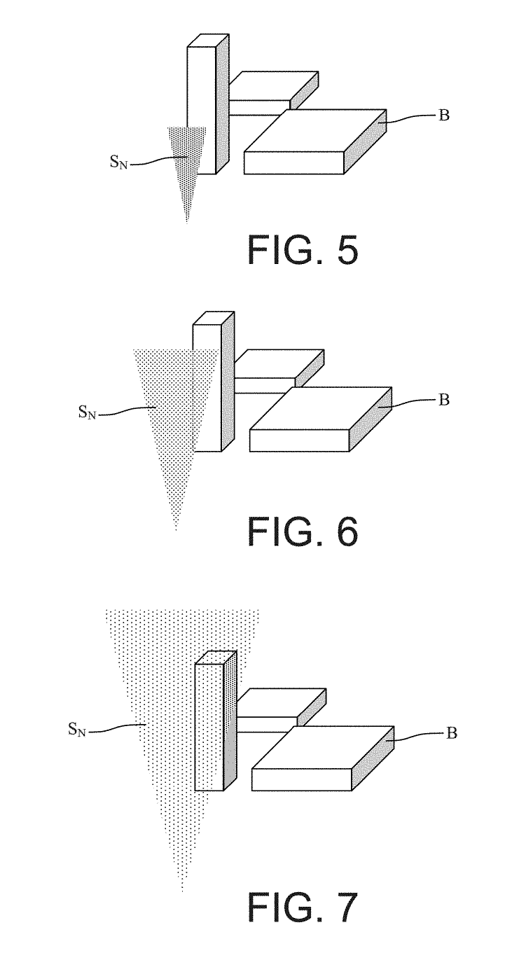

FIGS. 5, 6 and 7 represent the third step of display of a geo-referenced symbol according to the invention according to the surface area occupied by said symbol;

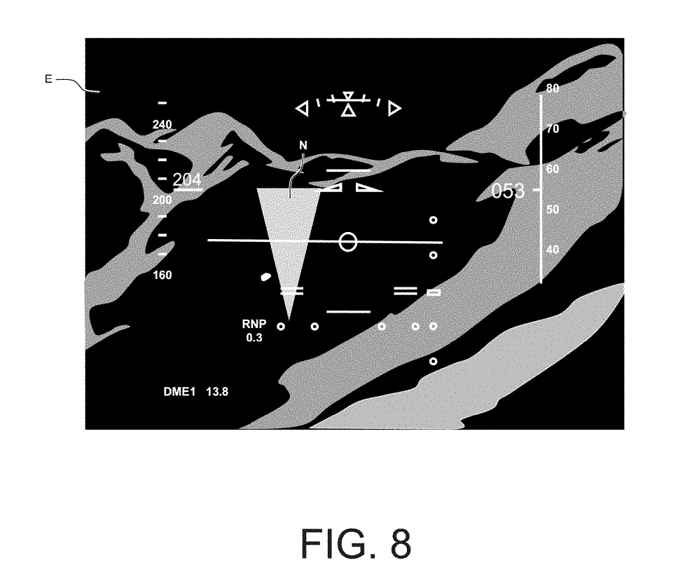

FIG. 8 represents a synthetic representation of a terrain comprising a navigation symbology and a waypoint of the flight plan of the aircraft according to the invention.

The implementation of the method according to the invention is carried out in an onboard viewing system. Various types thereof exist, known by the acronyms “SVS”, standing for “Synthetic Vision System”, “EVS”, standing for “Enhanced Vision System” or “CVS”, standing for “Computed Vision System”. These various onboard systems comprise a certain number of technical means, necessary for the implementation of the method. These are essentially:

a navigation system comprising, for example, an inertial platform, geolocation means of “GPS” type;

a first cartographic database of the terrain overflown;

a second database of geo-referenced points of interest such as airports, aeronautical waypoints or beacons;

electronic calculation means and;

a viewing device displaying a cartographic representation of the terrain overflown on a viewing screen E.

The viewing device can be a head-down screen, a so-called “HUD” head-up screen comprising an optical mixer, an imager worn in a helmet, the windshield of the aircraft on which the image is projected or any other onboard viewing device comprising a display screen.

The viewing device can display a transparent or opaque, monochrome or color image.

When the system according to the invention displays a symbol representing a geo-referenced object, the method for managing and displaying said symbol comprises the following three steps:
Step 1: Calculation of the total surface area of the geo-referenced symbol to be displayed on the viewing device;
Step 2: Calculation of a photometric and/or colorimetric coefficient representative of the geo-referenced symbol, said photometric and/or colorimetric coefficient being a decreasing function of the ratio of said total surface area to the surface area of the screen E;
Step 3: Display of said symbol by the viewing system on the viewing device.
These various calculations are carried out by the onboard electronic calculation means.

These various steps are detailed hereinbelow. Step 1 is represented in FIG. 3. In this and the following figures, the displayed symbol has the shape of a thin triangle whose tip is directed downwards. Of course, the method according to the invention operates with any shape of symbol.

The following parameters are then defined:

H: the height of the viewing screen in pixels

L: the width of the viewing screen in pixels

I_{P}: the maximum intensity of a pixel

I_{Total}: the total display intensity of the screen with all its pixels displayed without transparency. We have the simple relation:

I_{Total}=H*L*I_{P}

S_{N}: the total displayed surface area of the symbol N in pixels, including the part not displayed on the screen.

It is important to take into account the part not displayed of the symbol on the screen in the calculation of the surface area Sₙ of the object N for the following reason. If only the displayed part were taken into account, then when the object began to exit the screen, its footprint would decrease and would give rise to an artificial increase in its representative photometric and/or colorimetric coefficient.

In a second step, a photometric and/or colorimetric coefficient representative of the geo-referenced symbol is calculated, said photometric and/or colorimetric coefficient being a decreasing function of the ratio of said total surface area to the surface area of the screen. This photometric and/or colorimetric coefficient may be a coefficient of opacity or of luminance or of hue or of saturation according to the viewing device and the representation of the chosen terrain which may be a three-dimensional or two-dimensional view. It is also possible to choose to blur the contour of the symbol more or less. Of course, these various effects can be combined.

In what follows and by way of example, the coefficient employed is the coefficient of opacity of the symbol on the background of the landscape.

The principle of the calculation consists in defining a value of global luminous intensity I_{N} of the symbol N equal to its total surface area in pixels S_{N} multiplied by an opacity coefficient C_{N} of the pixels. We have the relation:

I_{N}=S_{N}*C_{N}

When the object is totally transparent, this opacity coefficient C_{N} is zero or nearly nil. When the object is totally opaque, this opacity coefficient C_{N} is nearly 100%. This opacity coefficient C_{N} is applied uniformly to all the pixels representing the symbol N.

As seen in FIG. 4, this opacity coefficient C_{N} is a decreasing function of the ratio of the total surface area S_{N} to the surface area of the screen H*L. Consequently, the more the symbol N occupies a considerable surface area S_{N} on the screen, the more transparent it becomes.

The intensity I_{N} is adjusted by modifying the opacity coefficient C_{N} so as not to exceed a maximum intensity value I_{MAX}. More precisely, this intensity value I_{MAX} satisfies the simple relation:

I_{MAX}=I_{Total}*C

C is a constant coefficient whose value is generally a few percent. This value is adjusted as a function of the symbol, of the type of graphical representation and of the type of viewing screen.

As seen in FIG. 4, the opacity C_{N} of the symbol varies between two extreme values C_{NMIN} and C_{NMAX}. The coefficient C_{NMIN} corresponds to the minimum opacity coefficient for any symbol. By way of example, it lies between 10% and 20% if it is desired to preserve a little visibility for objects with large footprint on the screen. When it is zero, the symbol disappears totally from the display. The coefficient C_{NMAX} corresponds to the maximum opacity coefficient for any symbol. By way of example, it lies between 80% and 100%. When it is equal to 100%, the symbol is totally opaque.

By way of example, the decreasing function representative of the opacity coefficient C_{N} as a function of the surface area S_{N} may be of the following form.

If S_{N}*C_{NMAX}≤I_{MAX} then C_{N}=C_{NMAX}

If S_{N}*C_{NMAX}>I_{MAX} and S_{N}*C_{NMIN}≤I_{MAX} then C_{N}=I_{MAX}/S_{N}

If S_{N}*C_{NMIN}>I_{MAX} then C_{N}=C_{NMIN}

When the surface area S_{N} is in the intermediate case, then we have the simple relation:

I_{N}=S_{N}*C_{N}=I_{MAX}

The global intensity of the symbol becomes a constant.

FIGS. 5, 6 and 7 illustrate these changes of opacity coefficient C_{N} with the size of the surface area S_{N}. These figures represent a triangular symbol S_{N} on a landscape background represented symbolically by buildings B.

In FIG. 5, the symbol has a small surface area, its opacity coefficient C_{N} is considerable, nearly 100%. It is opaque and hides the buildings B situated in the background.

In FIG. 6, the symbol has an average surface area, its opacity coefficient C_{N} is nearly 50%. It is semi-transparent and masks in part the buildings B situated in the background.

In FIG. 7, the symbol has a considerable surface area, its opacity coefficient C_{N} is almost zero. It is almost totally transparent and weakly masks the buildings B situated in the background.

FIG. 8 represents the same view as FIG. 2. In this figure, the triangular symbol N is represented in semi-transparency with the method according to the invention. Thus, the landscape and the symbology which are masked by the symbol N become in part visible again.

The person skilled in the art knows how to adapt the above calculations dedicated to the opacity coefficient of other photometric or colorimetric parameters such as the hue or the luminance of the symbol. For example, in the case of the hue, it is possible to vary its saturation as a function of the magnitude of the total surface area of the symbol N.

1. A method for managing and displaying a geo-referenced symbol (N), said method being implemented in a synthetic viewing system of an aircraft, said viewing system comprising at least one navigation system, a cartographic database, electronic calculation means and a viewing device displaying on a viewing screen a cartographic representation of the terrain overflown, said geo-referenced symbol representing an object which is itself geo-referenced, wherein said method comprises the following steps:
Step 1: Calculation of the total surface area (S_{N}) of the geo-referenced symbol to be displayed on the viewing device;
Step 2: Calculation of a photometric and/or colorimetric coefficient (C_{N}) representative of the geo-referenced symbol, said photometric and/or colorimetric coefficient being a decreasing function of the ratio of said total surface area to the surface area of the screen,
when the ratio of the total surface area to the surface area of the screen is less than a first threshold, said photometric and/or colorimetric coefficient is constant and equal to a maximum value (C_{NMAX});
when the ratio of the total surface area to the surface area of the screen is greater than a second threshold, said photometric and/or colorimetric coefficient is constant and equal to a minimum value (C_{NMIN});
when the ratio of the total surface area to the surface area of the screen lies between the first threshold and the second threshold, said photometric and/or colorimetric coefficient is inversely proportional to the ratio of the total surface area of the symbol to the surface area of the screen;
Step 3: Display of said geo-referenced symbol by the viewing system on the screen (E) of the viewing device.

2. The method for managing and displaying a geo-referenced symbol as claimed in claim 1, wherein the cartographic representation of the terrain overflown is a two-dimensional view from above.

3. The method for managing and displaying a geo-referenced symbol as claimed in claim 1, wherein the cartographic representation of the terrain overflown is a three-dimensional perspective view.

4. The method for managing and displaying a geo-referenced symbol as claimed in claim 1, wherein the first threshold and the second threshold are dependent on the size of the screen of the viewing device.

5. The method for managing and displaying a geo-referenced symbol as claimed in claim 1, wherein said photometric and/or colorimetric coefficient is a coefficient of opacity or of luminance or of hue or of saturation.

6. The method for managing and displaying a geo-referenced symbol as claimed in claim 1, wherein the outline of the symbol is blurred, the thickness of blur being an increasing function of the total surface area of said conformal symbol.

7. A synthetic viewing system comprising at least one navigation system, a cartographic database comprising at least one geo-referenced object, electronic calculation means making it possible to calculate a symbol which is itself geo-referenced representative of said geo-referenced object and a viewing device comprising a viewing screen displaying a cartographic representation of the terrain overflown, wherein said electronic calculation means are arranged so as to calculate the total surface area of the geo-referenced symbol to be displayed on the viewing device and a photometric and/or colorimetric coefficient representative of said geo-referenced symbol, said photometric and/or colorimetric coefficient being a decreasing function of said total surface area on the surface area of the screen,
when the ratio of the total surface area to the surface area of the screen is less than a first determined threshold, said photometric and/or colorimetric coefficient is constant and equal to a minimum value;
when the ratio of the total surface area to the surface area of the screen is greater than a second determined threshold, said photometric and/or colorimetric coefficient is constant and equal to a maximum value;
when the ratio of the total surface area to the surface area of the screen lies between the first threshold and the second threshold, said photometric and/or colorimetric coefficient is inversely proportional to the size of the total surface area.

8. The synthetic viewing system as claimed in claim 7, wherein the first threshold and the second threshold are dependent on the size of the viewing screen of the viewing device.

9. The synthetic viewing system as claimed in claim 7, wherein said photometric and/or colorimetric coefficient is a coefficient of opacity or of luminance or of hue or of saturation.

10. The synthetic viewing system as claimed in claim 7, wherein the outline of the symbol is blurred, the thickness of blur being an increasing function of the total surface area of said geo-referenced symbol.

11. The synthetic viewing system as claimed in claim 7, wherein the viewing device is:
either a so-called “Head-Up” viewing device comprising an optical mixer making it possible to display the geo-referenced symbol;
on an outside landscape;
or a head-mounted viewing device comprising an optical mixer making it possible to display the geo-referenced symbol on an outside landscape;
or an instrument panel viewing device comprising a color viewing screen.

12. The synthetic viewing system as claimed in claim 7, wherein the graphical representation of the symbol is a two-dimensional view from above.

13. The synthetic viewing system as claimed in claim 7, wherein the graphical representation of the symbol is a three-dimensional perspective view.

14. The synthetic viewing system as claimed in claim 12, wherein the graphical representation of the symbol is represented on a synthetic cartographic background.
